(19) United States
(12) Patent Application Publication
(10) Pub. No.: US 2012/0212746 A1
(43) Pub. Date: Aug. 23, 2012

(54) INTERFEROMETER AND MEASUREMENT METHOD

(75) Inventor: Akihiro HATADA, Utsunomiya-shi (JP)

(73) Assignee: CANON KABUSHIKI KAISHA, Tokyo (JP)

(21) Appl. No.: 13/403,648

(22) Filed: Feb. 23, 2012

(30) Foreign Application Priority Data
Feb. 23, 2011 (JP) 2011-037517

(51) Int. Cl. G01B 11/02; G01B 9/02

(52) U.S. Cl. 356/498

(57) ABSTRACT

The present invention provides an interferometer that measures a distance between a reference object and a measurement object, the interferometer including a light splitting element configured to split light from a light source into two light beams and cause one of the light beams to enter the reference object and the other light beam to enter the measurement object, a detection unit configured to detect interference light between light reflected by the reference object and light reflected by the measurement object and output a signal of the interference light, and a processing unit configured to perform processing for obtaining the distance.

### BACKGROUND OF THE INVENTION

1. Field of the Invention

The present invention relates to an interferometer and a measurement method.

2. Description of the Related Art

Generally, the position of a stage used in an exposure apparatus or the like is measured by a laser distance measuring system that uses a laser interferometer, but the result of measurement (measured position) includes a non-linear error known as a cyclic error. The cyclic error occurs in an optical system of an interferometer due to an imperfection of a transmissive surface that generates unwanted multiple reflections and imperfection of optical elements such as retroreflectors or polarizers that generates unwanted ellipticity in polarization of the input beams. To address this, techniques for calculating (correcting) a cyclic error in an interferometer have been proposed in, for example, Japanese Patent Laid-Open No. 2008-510170 and U.S. Pat. No. 6,956,656.

Japanese Patent Laid-Open No. 2008-510170 discloses a technique in which, by using the fact that there is a difference in the amount of Doppler shift between a main interference signal of measurement light and reference light and a cyclic error caused by unwanted light, the cyclic error is calculated and corrected using the main interference signal and a reference signal preceding the main interference signal. The amount of Doppler shift can be expressed by v·n·p/λ, where v is the relative speed of a measurement object and a reference object, λ is the wavelength of measurement light and reference light, n is the refractive index of a medium through which the measurement light and the reference light travel such as air or a vacuum, and p is the number of paths from the reference object to the measurement object (2 in the case of a single-pass interferometer, and 4 in the case of a double-pass interferometer).

FIG. 7 is a diagram illustrating the overview of the technique disclosed in Japanese Patent Laid-Open No. 2008-510170. As shown in FIG. 7, in first processing 1001, an error function that indicates a cyclic error term of a main interference signal SIG1 is generated for each Doppler shifted frequency based on the main interference signal SIG1 and a reference signal SIG2 preceding the main interference signal SIG1. In second processing 1002, an error signal is generated based on the error function of each frequency generated in the first processing 1001. In third processing 1003, the error signal generated in the second processing 1002 is subtracted from the main interference signal SIG1 so as to obtain (determine) a measurement position (measurement length).

As described above, Japanese Patent Laid-Open No. 2008-510170 characterizes coefficients (amplitude, phase and the like) representing each cyclic error term by separating the cyclic error term for a specific amount of Doppler shift from the main interference signal. For example, a Doppler shifted frequency is obtained by computing the main interference signal and an orthogonal signal whose phase has been inverted relative to the main interference signal, which is then subjected to low pass filtering, and thereby the amplitude and phase of the cyclic error term can be obtained. Then, an error signal generated from the amplitude and phase of the cyclic error terms is subtracted from the main interference signal, and thereby the cyclic error is reduced, and therefore the accuracy of measurement can be improved. Japanese Patent Laid-Open No. 2008-510170 calculates the cyclic error included in the main interference signal by using the fact that the amount of Doppler shift that depends on the moving speed of the measurement object differs according to the cyclic error.

U.S. Pat. No. 6,956,656 discloses a technique in which a cyclic error included in an interference signal during a second period of time in which cyclic error calculation is not possible is corrected (calculated) using a correction coefficient of a cyclic error obtained from an interference signal during a first period of time in which cyclic error calculation is possible.

However, with the technique disclosed in Japanese Patent Laid-Open No. 2008-510170, when the measurement object moves at a low speed or stays still, or in other words, when it is not possible to make a distinction between the Doppler shifted frequency and the frequency of the main interference signal, the cyclic error cannot be calculated due to limitation of the frequency resolution of a phase meter. On the other hand, with the technique disclosed in U.S. Pat. No. 6,956,656, the cyclic error can be calculated even when the measurement object moves at a low speed or stays still, but the cyclic error in real time is substituted by one correction coefficient of a cyclic error obtained in the past (in other words, one correction value). Accordingly, the correction accuracy of cyclic error decreases with temporal changes of the cyclic error, and as a result the measurement accuracy is limited.

### SUMMARY OF THE INVENTION

The present invention provides a technique advantageous in measuring the distance between a reference object and a measurement object.

According to one aspect of the present invention, there is provided an interferometer that measures a distance between a reference object and a measurement object, the interferometer including a light splitting element configured to split light from a light source into two light beams and cause one of the light beams to enter the reference object and the other light beam to enter the measurement object, a detection unit configured to detect interference light between light reflected by the reference object and light reflected by the measurement object and output a signal of the interference light, and a processing unit configured to perform processing for obtaining the distance using a detection result by the detection unit, wherein the processing unit performs the following fixing a wavelength of the light from the light source, causing the light to enter the reference object and the measurement object via an optical path including the light splitting element, and controlling the detection unit so as to detect interference light between light reflected by the reference object and light reflected by the measurement object and output a first signal, causing, while continuously changing the wavelength of the light from the light source, the light to enter the reference object and the measurement object via the optical path, and controlling the detection unit so as to detect interference light between light reflected by the reference object and light reflected by the measurement object and output a second signal, performing frequency analysis on the second signal to calculate a cyclic error included in the second signal, identifying a cyclic error included in the first signal corresponding to the cyclic error included in the second signal that has been calculated, by using a table showing a correspondence relationship between the cyclic error included in the first signal and the cyclic error included in the second signal, and subtracting the identified cyclic error from the first signal, and obtaining a phase corresponding to an optical path length between the reference object and the measurement objectusing the first signal from which is subtracted the identified cyclic error.

Further aspects of the present invention will become apparent from the following description of exemplary embodiments with reference to the attached drawings.

### BRIEF DESCRIPTION OF THE DRAWINGS

FIG. 1 is a diagram schematically showing processing for obtaining the distance between a reference object and a measurement object, performed by a processing unit of an interferometer according to one aspect of the present invention.

FIG. 2 is a schematic diagram showing a configuration of an interferometer according to a first embodiment of the present invention.

FIG. 3 is a diagram showing an example in which the wavelength of light from a second light source is continuously changed in the interferometer shown in FIG. 2.

FIG. 4 is a flowchart illustrating processing for obtaining the absolute distance between a reference object and a measurement object, performed by a processing unit of the interferometer shown in FIG. 2.

FIG. 5 is a schematic diagram showing a configuration of an interferometer according to a second embodiment of the present invention.

FIG. 6 is a schematic diagram showing a configuration of an interferometer according to a third embodiment of the present invention.

FIG. 7 is a diagram illustrating a technique for calculating (correcting) a cyclic error in an interferometer.

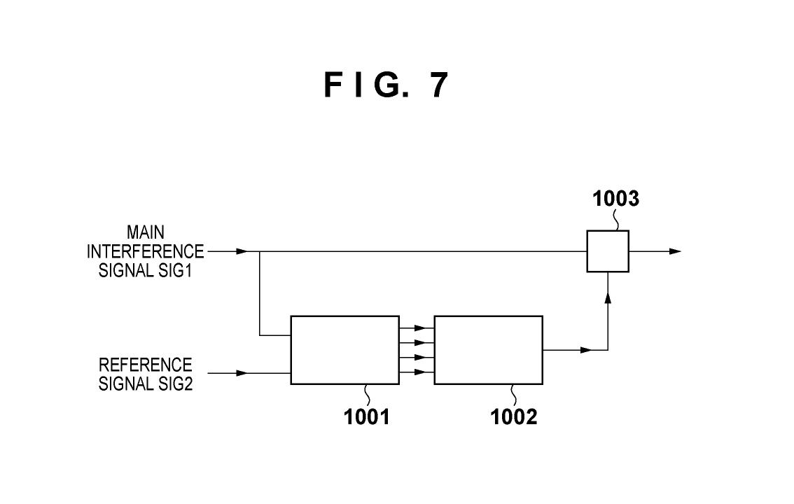

### DESCRIPTION OF THE EMBODIMENTS

Preferred embodiments of the present invention will be described below with reference to the accompanying drawings. Note that the same reference numerals denote the same members throughout the drawings, and a repetitive description thereof will not be given.

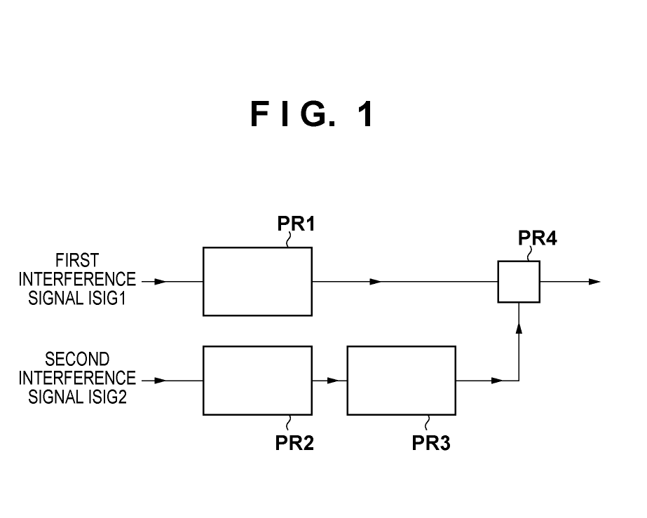

FIG. 1 is a diagram schematically showing processing for obtaining the distance between a reference object and a measurement object, performed by a processing unit of an interferometer according to one aspect of the present invention. As will be described later, this processing involves processing for reducing a cyclic error included in the signal of interference light between light reflected by the reference object and light reflected by the measurement object.

In first processing PR1, the wavelength of light from a light source is stabilized (or in other words, the wavelength of light from the light source is fixed), and a first interference signal (first signal) ISIG1 that is the signal of interference light between light reflected by the reference object and light reflected by the measurement object is obtained. In second processing PR2, a second interference signal (second signal) ISIG2 having a rate of change of interferometric phase different from that of the first interference signal ISIG1 is obtained. In third processing PR3, the second interference signal ISIG2 obtained in the second processing PR2 is subjected to frequency analysis to detect the frequency of a signal included in the second interference signal ISIG2, and a cyclic error is calculated by obtaining an amplitude and phase of the signal at the detected frequency. In fourth processing PR4, a cyclic error included in the first interference signal ISIG1 is identified from the cyclic error calculated in the third processing PR3, the identified cyclic error is subtracted from the first interference signal ISIG1, and the obtained result is used to calculate a phase corresponding to the optical path length between the reference object and the measurement object.

Hereinafter, the configuration of an interferometer and processing for obtaining the distance between a reference object and a measurement object according to one aspect of the present invention will be described in each embodiment.

### First Embodiment

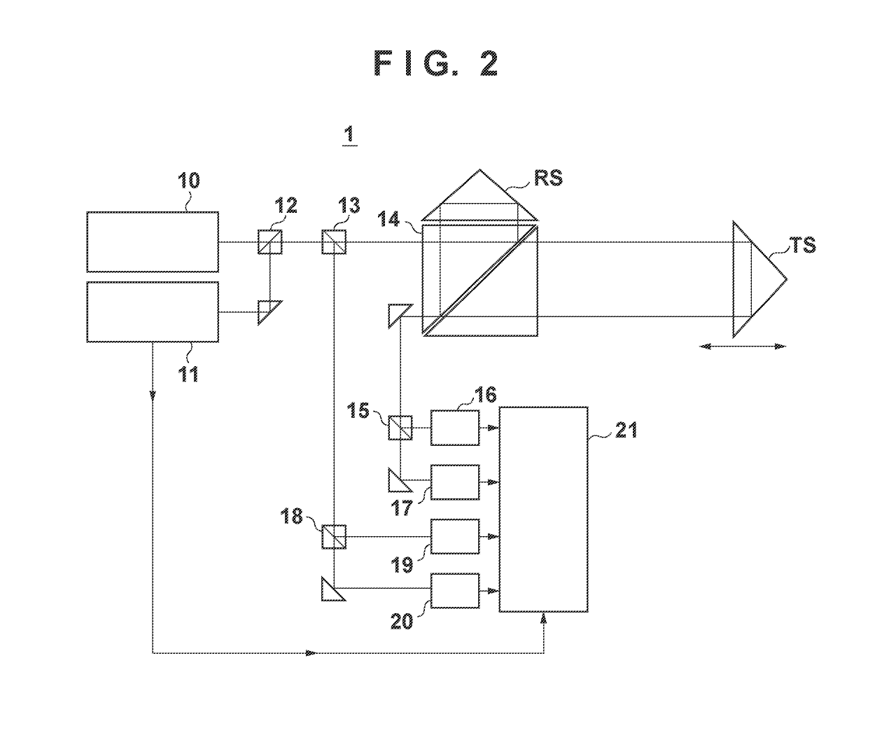

FIG. 2 is a schematic diagram showing a configuration of an interferometer 1 according to a first embodiment. The interferometer 1 is a light wave interferometer that measures the distance between a reference object and a measurement object. In the present embodiment, the interferometer 1 is embodied as an interferometer using heterodyne interferometry. However, the interferometer 1 is not limited to an interferometer using heterodyne interferometry, and may be an interferometer using homodyne interferometry.

The interferometer 1 includes a first light source (fixed wavelength light source) 10, a second light source (tunable wavelength light source) 11, a coupling mirror 12, a beam splitter 13, a polarizing beam splitter 14, a first light separator element 15, a first detection unit 16, and a second detection unit 17. Furthermore, the interferometer 1 includes a second light separator element 18, a third detection unit 19, a fourth detection unit 20, and a processing unit 21.

The first light source 10 and the second light source 11 are controlled using the absorption line of gas contained in a gas cell, the transmission spectrum of a Fabry-Perot etalon or the like such that the wavelength of the emitted light is stabilized. For example, the wavelength of the light emitted from the first light source 10 is stabilized to a first reference wavelength λ₁. The wavelength of light emitted from the second light source 11 is stabilized to a second reference wavelength λ₂ or third reference wavelength λ₃, and can be continuously changed (scanned) between the second reference wavelength λ₂ and the third reference wavelength λ₃. With the light emitted from the first light source 10, the frequencies of orthogonal polarization components differ from each other by ω_{R}. Similarly, with the light emitted from the second light source 11, the frequencies of orthogonal polarization components differ from each other by ω_{R}. Accordingly, the first light source 10 and the second light source 11 function as heterodyne light sources. In the present embodiment, the first light source 10 and the second light source 11 are configured as light sources independent of each other, but it is also possible to, for example, configure a light source by integrating a plurality of semiconductor lasers on a single element, as with a multi-wavelength light source used in optical communication. This is advantageous in terms of cost and size of the apparatus.

The coupling mirror 12 adjusts the light from the first light source 10 and the light from the second light source 11 such that the beam axis and polarization angle of the light from the first light source 10 and those of the light from the second light source 11 match each other. The beam splitter 13 allows part of the light from the first light source 10 and the second light source 11 to pass therethrough so as to guide the light to the polarizing beam splitter 14, and reflects the remaining part of the light so as to guide the light to the second light separator element 18.

The polarizing beam splitter 14 is disposed such that its polarization angle matches the polarization direction of the light from the first light source 10 and the second light source 11, and splits each of the light from the first light source 10 and the light from the second light source 11 into two light beams. Out of the two light beams obtained as a result of splitting by the polarizing beam splitter 14, the light reflected by the polarizing beam splitter 14 enters a reference object RS, and the light passing through the polarizing beam splitter 14 enters a measurement object TS. As described above, the polarizing beam splitter 14 functions as a light splitting element that splits each of the light from the first light source 10 and the light from the second light source 11 into two light beams and causes one of the light beams to enter the reference object RS and the other light beam to enter the measurement object TS.

The reference object RS is configured with, for example, a corner cube having a plurality of reflective surfaces, and is fixed to a reference structure serving as a reference for distance measurement. The measurement object TS is also configured with a corner cube, as with the reference object RS, and is fixed to a target object (measurement object) for distance measurement.

The light reflected by the reference object RS (reference light) and the light reflected by the measurement object TS (measurement light) are combined by the polarizing beam splitter 14 (or in other words, combined into interference light), then entering the first light separator element 15. The first light separator element 15 is configured with, for example, a dichroic mirror, and separates the light from the first light source 10 and the light from the second light source 11. In the present embodiment, the first light separator element 15 reflects the light from the first light source 10 and allows the light from the second light source 11 to pass therethrough.

The light reflected by the first light separator element 15 (the light from the first light source 10) enters the first detection unit 16, and the light that has passed through the first light separator element 15 (the light from the second light source 11) enters the second detection unit 17. Each of the first detection unit 16 and the second detection unit 17 detects interference light between the light reflected by the reference object RS and the light reflected by the measurement object TS. Then, each of the first detection unit 16 and the second detection unit 17 outputs an interference signal that is a heterodyne signal (or in other words, the signal of interference light between the light reflected by the reference object RS and the light reflected by the measurement object TS) to the processing unit 21.

The second light separator element 18 is configured with, for example, a dichroic mirror, and separates the light from the first light source 10 and the light from the second light source 11. In the present embodiment, the second light separator element 18 reflects the light from the first light source 10 and allows the light from the second light source 11 to pass therethrough.

The light reflected by the second light separator element 18 (the light from the first light source 10) enters the third detection unit 19, and the light that has passed through the second light separator element 18 (the light from the second light source 11) enters the fourth detection unit 20. A heterodyne signal is detected by each of the third detection unit 19 and the fourth detection unit 20 and input into the processing unit 21 as a reference interference signal.

The processing unit 21 includes a CPU, a memory and the like, and controls the constituent elements of the interferometer 1. As mentioned in the description of FIG. 1, the processing unit 21 performs processing for obtaining the distance between the reference object RS and the measurement object TS. Hereinafter, the processing for obtaining the distance between the reference object RS and the measurement object TS, performed by the processing unit 21 will be described in detail.

First, obtainment of the first interference signal ISIG1 (the first processing PR1) will be described. In this processing, the processing unit 21 fixes the wavelength of the light from the first light source 10, causes the light to enter the reference object RS and the measurement object TS via an optical path including the polarizing beam splitter 14, and controls the detection units so as to detect the first interference signal ISIG1.

A measurement interference signal I_{M1} (t) detected by the first detection unit 16 and a reference interference signal I_{R1} (t) detected by the second detection unit 17 can be expressed by the following Equation 1, respectively. In Equation 1, A_{M1} indicates amplitude, φ₁₀ indicates initial phase, ω_{R} is the frequency difference between orthogonal polarization components, or in other words, the reference frequency of the heterodyne signal.

I_{R1}(t)=A_{R1} cos(ω_{R}t+φ₁₀)

I_{M1}(t)=A_{M1} cos((ω_{R}+ω_{D1})t+φ₁+φ₁₀) (Equation 1)

If the position of the measurement object TS at a given time t is indicated by Lⱼ, and the moving speed of the measurement object TS is indicated by v, then, an amount ω_{D1} of Doppler shift due to movement of the measurement object TS and a phase φ₁ that depends on the optical path length difference between the measurement light and the reference light can be expressed by the following Equations 2 and 3. As shown in FIG. 2, because the interferometer 1 has a single-pass configuration, the number of paths from the reference object RS to the measurement object TS is set to 2. n₁ is the average refractive index in the measurement optical path.

$$\begin{matrix}{ω}_{D 1} = 2 {vn}_{1} {k}_{1} \\ {φ}_{1} = 2 {n}_{1} {k}_{1} {L}_{j} & ( Equation 2 ) \\ where {k}_{1} = \frac{2 π}{{λ}_{1}} & ( Equation 3 )\end{matrix}$$

Fourier analysis such as discrete Fourier transform or fast Fourier transform, or fitting is performed on the frequency ω_{R}+ω_{D1} of the measurement interference signal I_{M1} (t) so as to calculate a phase φ₁+φ₁₀. Similar processing is performed on the reference interference signal I_{R1} (t) so as to calculate an initial phase φ₁₀. By subtracting the phase calculated from the reference interference signal I_{R1} (t), from the phase calculated from the measurement interference signal I_{M1} (t), a phase corresponding to the distance (optical path length) between the reference object RS and the measurement object TS can be obtained.

In reality, however, unwanted light due to imperfection of the optical system constituting the interferometer 1 is included, and therefore the measurement interference signal I_{M1} (t) includes a cyclic error CE₁ as expressed by the following Equation 4.

$${I}_{M 1} ( t ) = {A}_{M 1} cos ( ( {ω}_{R} + {ω}_{D 1} ) t + {φ}_{1} + {φ}_{10} ) + {CE}_{1} \\ {CE}_{1} = {\sum }_{m} {A}_{m 1} cos ( ( {ω}_{R} + m {ω}_{D 1} ) t + {φ}_{m 1} ) \qquad ( Equation 4 )$$

The cyclic error CE₁ is expressed by the sum with respect to interference signal obtained by multiplying the amount of Doppler shift of the measurement interference signal by a coefficient m. With this signal, when a phase corresponding to the frequency ω_{R}+ω_{D1} is calculated, a measurement value including the cyclic error CE₁ is obtained.

Next, obtainment of the second interference signal ISIG2 (the second processing PR2) will be described. In this processing, the processing unit 21 causes the light from the second light source 11 to enter the reference object RS and the measurement object TS via an optical path including the polarizing beam splitter 14 while continuously changing (scanning) the wavelength of the light, and controls the detection units so as to detect the second interference signal ISIG2. As described above, in the present embodiment, in order to obtain the second interference signal ISIG2 having a rate of change of interferometric phase different from that of the first interference signal ISIG1, the wavelength of the light from the second light source 11 is continuously changed.

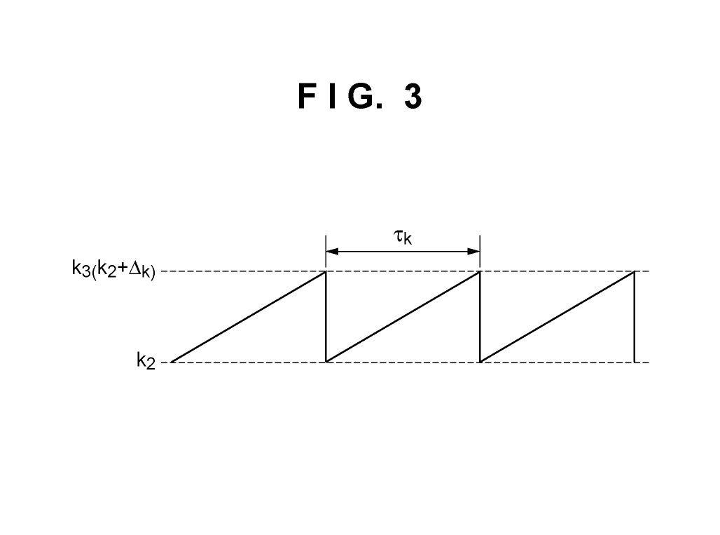

For example, as shown in FIG. 3, a case is considered in which the wave number of the light from the second light source 11 is continuously (linearly) changed (scanned) from a wave number k₂ (=2π/λ₂) to a wave number k₃ (=2π/λ₃) in a cycle of τ_{K}. In this case, a measurement interference signal I_{M2} (t) and a reference interference signal I_{R2} (t) can be expressed by the following Equation 5, respectively. In Equation 5, A_{R2} and A_{M2} indicate amplitudes, and φ₂₀ (t) indicates the initial phase.

I_{R2}t)=A_{R2} cos(ω_{R}t+φ₂₀(t))

I_{M2}(t)=A_{M2} cos((ω_{R}+ω_{D2}+ω_{K}(t))t+φ₂(t)+φ₂₀(t)) (Equation 5)

If the wave number of the light from the second light source 11 at a given time t is indicated by kⱼ, then, an amount ω_{D2} of Doppler shift due to movement of the measurement object TS can be expressed by the following Equation 6. Also, an amount ω_{K} (t) of frequency shift is the amount of frequency shift caused by changing (scanning) the wave number and can be expressed by the following Equation 7. Also, a phase T2 corresponding to the distance (optical path length difference) between the reference object RS and the measurement object TS can be expressed by the following Equation 8. In the equations, n₂ is the average refractive index in the measurement optical path between the corresponding wavelengths.

$$\begin{matrix}{ω}_{D 2} = 2 {vn}_{2} {k}_{j} \\ {ω}_{K} ( t ) = 2 {n}_{2} {α}_{k} ( L + v t ) & ( Equation 6 ) \\ where {α}_{k} = \frac{( {k}_{3} - {k}_{2} )}{{τ}_{k}} & ( Equation 7 ) \\ {φ}_{2} = 2 {n}_{2} {k}_{j} {L}_{j} \\ where {k}_{2} = 2 π / {λ}_{2} & ( Equation 8 )\end{matrix}$$

However, unwanted light due to imperfection of the optical system constituting the interferometer 1 is included, and therefore the measurement interference signal I_{M2} (t) includes a cyclic error CE₂ as expressed by the following Equation 9 (in other words, as with the measurement interference signal I_{M1} (t)).

$${I}_{M 2} ( t ) = {A}_{M 2} cos ( ( {ω}_{R} + {ω}_{D 2} + {ω}_{K} ( t ) ) t + {φ}_{2} + {φ}_{20} ) + {CE}_{2} \\ {CE}_{2} = {\sum }_{m} {A}_{2 m} cos ( ( {ω}_{R} + m ( {ω}_{D 2} + {ω}_{K} ( t ) ) ) t + {φ}_{2 m} ( t ) ) \qquad ( Equation 9 )$$

Next, frequency analysis performed on the second interference signal ISIG2 and identification of the cyclic error included in the second interference signal ISIG2 (the third processing PR3) will be described next. In this processing, it is assumed that Fourier analysis is used for the measurement interference signal I_{M2} (t) in order to obtain the amplitude (amplitude term) A_{M2} and the phase (phase term) φ₂ₘ of the cyclic error at each frequency.

When the measurement interference signal I_{M2} (t) is subjected to fast Fourier transform (FFT), the frequency ω_{R}+ω_{D2}+ω_{K} (t) of the interference signal and the signal frequency ω_{R}+m(ω_{D2}+ω_{K} (t)) of the cyclic error are detected. Accordingly, the amount of frequency shift is expressed by the sum of ω_{D2} and ω_{K}, and therefore even if the measurement object TS stays still and ω_{D2} is zero, frequencies can be separated. The amplitude and the phase are obtained by applying Fourier analysis such as discrete Fourier transform (DFT) to each frequency detected in the above-described manner, and the cyclic error CE₂ of each frequency component is calculated. Fourier analysis is well known in the art, and thus a detailed description thereof is not given here.

Next, calculation of a phase corresponding to the optical path length between the reference object RS and the measurement object TS (the fourth processing PR4) will be described. In order to calculate a phase corresponding to the optical path length between the reference object RS and the measurement object TS, it is necessary to prepare (obtain) in advance a table showing the correspondence relationship between the cyclic error (CE₁) included in the first interference signal and the cyclic error (CE₂) included in the second interference signal. For example, measurement length values are obtained using each of the light from the first light source 10 and the light from the second light source 11 while the measurement object TS is moved at a known speed. Then, at the wavelength of each light source, the cyclic error term for the Doppler frequency at the known speed is separated, and the cyclic error term is expressed using coefficients, and the correspondence relationship is stored in the memory of the processing unit 21 in the form of a table.

The cyclic error CE₁ included in the first interference signal corresponding to the cyclic error CE₂ included in the second interference signal is identified by using such a table. Specifically, the phase Aₘ₁, the phase φₘ₁ and the amount ω_{D1} of Doppler shift of the cyclic error included in the measurement interference signal I_{M1} (t) are identified from the amplitude A_{M2}, the phase φ₂ₘ and the amount ω_{D2} of Doppler shift of the cyclic error included in the measurement interference signal I_{M2} (t). The identified cyclic error CE₁ is subtracted from the measurement interference signal I_{M1} (t), and from the obtained result, a phase corresponding to the optical path length between the reference object RS and the measurement object TS is calculated.

In the present embodiment, even when the measurement object TS moves at a low speed or stays still, the cyclic error CE₁ included in the measurement interference signal I_{M1} (t) can be removed (reduced). Accordingly, a phase corresponding to the optical path length between the reference object RS and the measurement object TS, or in other words, the distance between the reference object RS and the measurement object TS can be obtained with high accuracy.

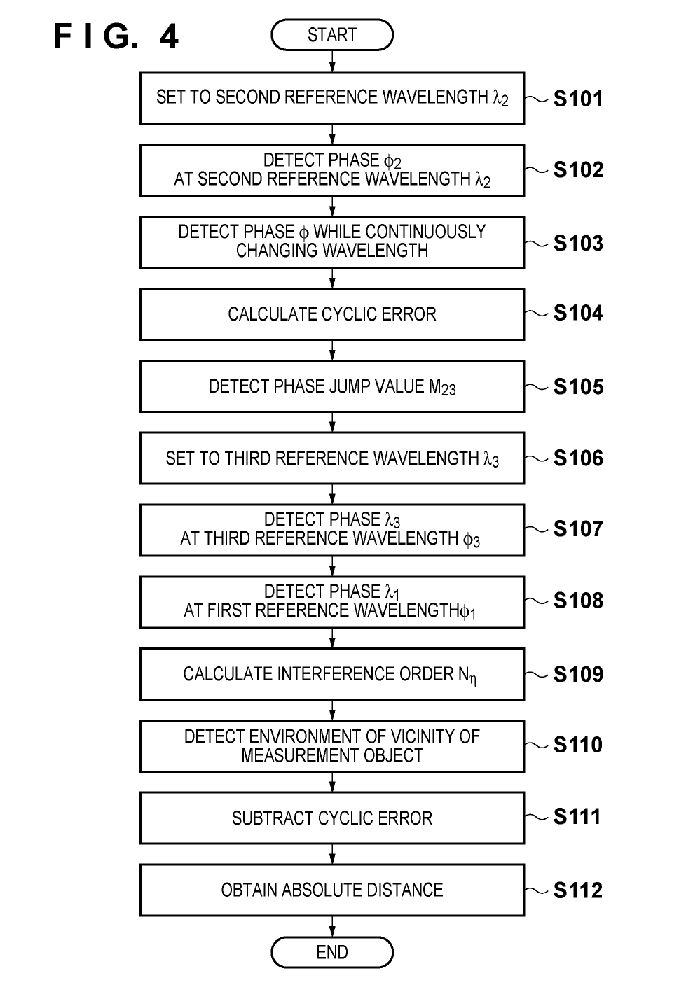

Also, as shown in FIG. 4, the processing unit 21 is also capable of performing processing for obtaining the absolute distance between the reference object RS and the measurement object TS. FIG. 4 is a flowchart illustrating processing for obtaining the absolute distance between the reference object RS and the measurement object TS, performed by the processing unit 21.

In step S101, the wavelength of the light emitted from the second light source 11 is set to the second reference wavelength λ₂ (in other words, control is started so as to stabilize the wavelength to the second reference wavelength λ₂).

In step S102, the phase φ₂ at the second reference wavelength λ₂ is detected. As used herein, “to detect the phase” means to detect the phase difference between the measurement interference signal and the reference interference signal. Accordingly, the phase φ₂ at the second reference wavelength λ₂ can be detected by the processing unit 21 calculating the phase of the measurement interference signal and the phase of the reference interference signal and obtaining the difference between the calculated phases.

The phase φ₂ at the second reference wavelength λ₂ detected in step S102 can be expressed by the following Equation 10. In the equation, mod(u,w) indicates the excess of a first argument u with respect to a second first argument w. Also, n(λ) is the refractive index of the optical path of the measurement light at a wavelength λ, and D is the absolute distance between the reference object RS and the measurement object TS (the difference in optical path length between the reference object RS and the measurement object TS).

$${φ}_{2} = 2 π \times mod ( \frac{2 n ( {λ}_{2} ) D}{{λ}_{2}} , 1 ) \qquad ( Equation 10 )$$

In step S103, the phase φ is detected while the wavelength of the light emitted from the second light source 11 is continuously changed (scanned) from the second reference wavelength λ₂ (wave number k₂ (=2π/λ₂)) to the third reference wavelength λ₂ (wave number k₃ (=2π/λ₂)).

In step S104, a cyclic error is calculated from the phase φ detected in step S103. The calculation of the cyclic error is performed in the same manner as described above, and thus a detailed description thereof is not given here.

In step S105, a phase jump value M₂₃ generated by continuously changing the wavelength of the light emitted from the second light source 11 from the second reference wavelength λ₂ to the third reference wavelength λ₃ is detected. The phase range detectable by the processing unit 21 is ±π, and therefore if the phase range of ±π is exceeded, a phase jump occurs.

In step S106, the wavelength of the light emitted from the second light source 11 is set to the third reference wavelength λ₃ (in other words, control is started so as to stabilize the wavelength to the third reference wavelength λ₃).

In step S107, a phase φ₃ at the third reference wavelength λ₃ is detected. The phase φ₃ at the third reference wavelength λ₃ detected in step S107 can be expressed by the following Equation 11.

$${φ}_{3} = 2 π \times mod ( \frac{2 n ( {λ}_{3} ) D}{{λ}_{3}} , 1 ) \qquad ( Equation 11 )$$

Referring to Equations 10 and 11, the phase jump value M₂₃ detected in step S105 can be expressed by the following Equation 12. In the equation, Λ₂₃ is the synthetic wavelength of the second reference wavelength λ₂ and the third reference wavelength λ₃ expressed by λ₂·λ₃/|λ₃−λ₂|. n_{g}(λ₂, λ₃) indicates the group refractive index at the second reference wavelength λ₂ and the third reference wavelength λ₃.

$${M}_{23} = \frac{2 {n}_{g} ( {λ}_{2} , {λ}_{3} )}{{Λ}_{23}} - ( {φ}_{3} - {φ}_{2} ) \qquad ( Equation 12 )$$

In step S108, the phase φ₁ at the wavelength of the light emitted from the first light source 10, or in other words, at the first reference wavelength λ₁ is detected. The phase φ₁ at the first reference wavelength λ₁ detected in step S108 can be expressed by the following Equation 13.

$${φ}_{1} = 2 π \times mod ( \frac{2 n ( {λ}_{1} ) D}{{λ}_{1}} , 1 ) \qquad ( Equation 13 )$$

In step S109, an interference order (phase jump value) N₁ at the first reference wavelength λ₁ is calculated. The synthetic wavelength of the first reference wavelength λ₁ and the second reference wavelength λ₂ indicated by λ₁·λ₂/|λ₁−λ₂| is assumed to be indicated by Λ₂₂. In this case, the relationship between the absolute distance D between the reference object RS and the measurement object TS, the first reference wavelength λ₁ and the synthetic wavelength λ₂₂ can be expressed by the following Equations 14 and 15.

$$\begin{matrix}D = \frac{{λ}_{1}}{2 n ( {λ}_{1} )} ( {N}_{1} + \frac{{φ}_{1}}{2 π} ) & ( Equation 14 ) \\ D = \frac{{Λ}_{12}}{2 {n}_{g} ( {λ}_{1} , {λ}_{2} )} ( {M}_{12} + \frac{{φ}_{2} - {φ}_{1}}{2 π} ) & ( Equation 15 )\end{matrix}$$

Also, the relationship between the absolute distance D between the reference object RS and the measurement object TS, the third reference wavelength λ₃ and the synthetic wavelength Λ₂₃ can be expressed by the following Equation 16.

$$D = \frac{{Λ}_{23}}{2 {n}_{g} ( {λ}_{2} , {λ}_{3} )} ( {M}_{23} + \frac{{φ}_{3} - {φ}_{2}}{2 π} ) \qquad ( Equation 16 )$$

Because the relationship λ₁<Λ₁₂<<Λ₂₃ is satisfied by the first reference wavelength λ₁, the synthetic wavelength Λ₁₂ and the synthetic wavelength Λ₂₃, interference orders N₁ and M₁₂ can be expressed by the following Equation 17.

$$\{ \begin{matrix}{N}_{1} = round ( ( {M}_{12} + \frac{{φ}_{1} - {φ}_{2}}{2 π} ) \frac{n ( {λ}_{1} ) {Λ}_{12}}{{n}_{g} ( {λ}_{1} , {λ}_{2} ) {λ}_{1}} - \frac{{φ}_{1}}{2 π} ) \\ {M}_{12} = round ( ( {M}_{23} + \frac{{φ}_{3} - {φ}_{2}}{2 π} ) \frac{{n}_{g} ( {λ}_{2} , {λ}_{1} ) {Λ}_{23}}{{n}_{g} ( {λ}_{2} , {λ}_{3} ) {Λ}_{12}} - \frac{{φ}_{1} - {φ}_{2}}{2 π} )\end{matrix} \qquad ( Equation 17 )$$

In step S110, an environment detection unit (not shown) disposed in the vicinity of the measurement object TS is used to detect the environment of the vicinity of the measurement object TS, or in other words, the environment of space between the reference object RS and the measurement object TS. The environment detection unit includes, for example, a thermometer that detects the temperature of gas in the space between the reference object RS and the measurement object TS and a barometer that detects the atmospheric pressure of the space between the reference object RS and the measurement object TS, and the environment detection unit detects a group refractive index of the space (in other words, atmosphere) between the reference object RS and the measurement object TS.

In step S111, the cyclic error is subtracted from the phase φ₁ at the first reference wavelength λ₁ detected in step S108. As described above, the cyclic error included in the phase φ₁ corresponding to the cyclic error calculated in step S104 is identified using the table showing the correspondence relationship between the cyclic error included in the first interference signal and the cyclic error included in the second interference signal. Then, the identified cyclic error is subtracted from the phase φ₁.

In step S112, the absolute distance D between the reference object RS and the measurement object TS is calculated. Specifically, the refractive index of the space between the reference object RS and the measurement object TS is calculated from the result of detection in step S110, and the absolute distance D is obtained according to the following Equation 14. However, in the case where the interference order has been calculated, the absolute distance D can be obtained according to the following Equation 18.

$$D = \frac{{λ}_{1}}{2 n ( {λ}_{1} )} \\ ( \begin{matrix}round ( \begin{matrix}\frac{n ( {λ}_{1} )}{\begin{matrix}{n}_{g} \\ \begin{matrix}( {λ}_{2} , \\ {λ}_{1} )\end{matrix}\end{matrix}} \frac{{Λ}_{21}}{{λ}_{1}} ( \begin{matrix}round ( \begin{matrix}\frac{\begin{matrix}{n}_{g} \\ ( {λ}_{2} , {λ}_{1} )\end{matrix}}{\begin{matrix}{n}_{g} \\ ( {λ}_{2} , {λ}_{3} )\end{matrix}} \frac{2 {D}_{2}}{{Λ}_{21}} - \\ \frac{{φ}_{1} - {φ}_{2}}{2 π}\end{matrix} ) + \\ \frac{{φ}_{1} - {φ}_{2}}{2 π}\end{matrix} ) - \\ \frac{{φ}_{1}}{2 π}\end{matrix} ) + \\ \frac{{φ}_{1}}{2 π}\end{matrix} ) \qquad ( Equation 18 )$$

As described above, in the present embodiment, the cyclic error included in the phase φ₁ at the first reference wavelength λ₁ can be removed (reduced), and therefore the absolute distance between the reference object RS and the measurement object TS can be obtained with high accuracy.

In the present embodiment, the interferometer 1 includes two light sources (the first light source 10 and the second light source 11), but the interferometer 1 may include more than two light sources. In this case, the cyclic error included in the interference signal can be obtained with high accuracy by continuously changing (scanning) more than two wavelengths and averaging a plurality of results.

### Second Embodiment

In a second embodiment, the second interference signal ISIG2 having a rate of change of interferometric phase different from that of the first interference signal ISIG1 is obtained by modulating the phase of light, rather than by continuously changing the wavelength of light. In other words, the second embodiment is different from the first embodiment in the second processing PR2 for obtaining the second interference signal ISIG2. Accordingly, only the second processing PR2 will be described below, and descriptions of the first processing PR1, the third processing PR3 and the fourth processing PR4 are not given here.

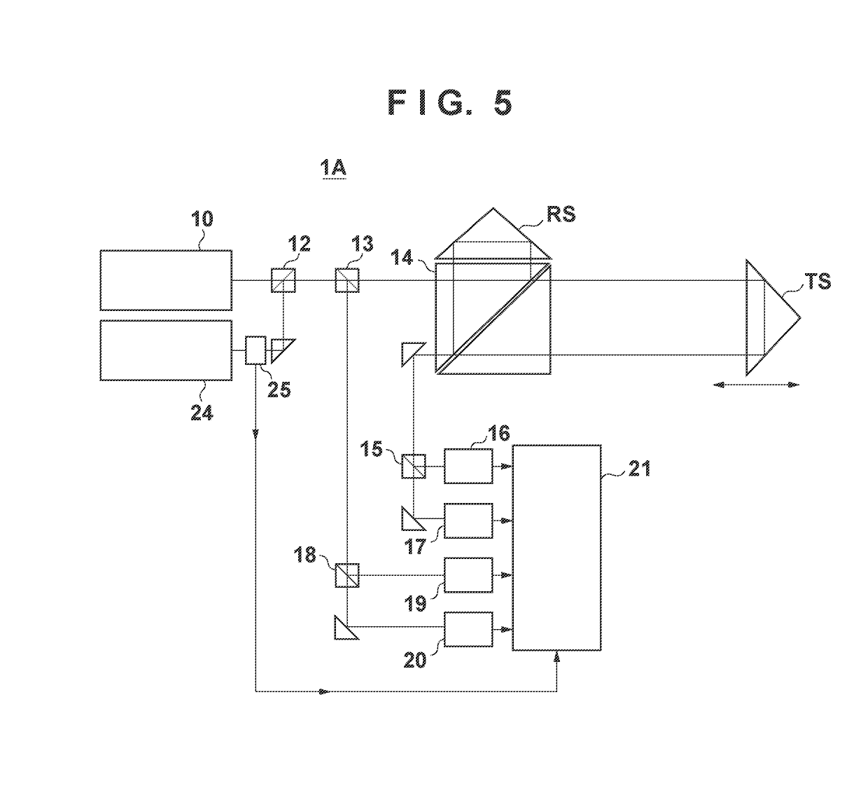

FIG. 5 is a schematic diagram showing a configuration of an interferometer 1A according to a second embodiment. The interferometer 1A basically has constituent elements similar to those of the interferometer 1, but it includes a third light source (fixed wavelength light source) 24 in place of the second light source 11 and further includes a light modulation unit 25.

The third light source 24 is controlled, in the same manner as the first light source 10, such that the wavelength of the emitted light is stabilized to a reference wavelength. With the light emitted from the third light source 24, the frequencies of orthogonal polarization components differ from each other by ω_{R}. The light modulation unit 25 includes, for example, an electrooptic modulator (EOM), and modulates the phase of the light emitted from the third light source 24.

Obtainment of the second interference signal ISIG2 (the second processing PR2) will be described. In this processing, the processing unit 21 causes the light from the third light source 24 to enter the reference object RS and the measurement object TS via an optical path including the polarizing beam splitter 14 while modulating the phase of the light with the light modulation unit 25, and controls the detection units so as to detect the second interference signal ISIG2.

For example, if the amount of modulation of the phase of the light from the third light source 24 is indicated by β, and the modulation cycle of the phase of the light from the third light source 24 is indicated by τ_{P}, then, the measurement interference signal I_{M2} (t) and a cyclic error CE₂ₚ included in the measurement interference signal I_{M2} (t) can be expressed by the following Equation 19.

$${I}_{M 2} ( t ) = {A}_{M 2} cos ( ( {ω}_{R} + {ω}_{D 2} + {ω}_{P} ) t + {φ}_{2} + {φ}_{20} ( t ) ) + {CE}_{2 p} \\ {CE}_{2 p} = {\sum }_{m} {A}_{2 m} cos ( ( {ω}_{R} + m ( {ω}_{D 2} + {ω}_{P} ) ) t + {φ}_{2 m} ( t ) ) \qquad ( Equation 19 )$$

In the equations, ω_{P} (=2n₂k₂β/τ_{P}) is the amount of frequency shift caused by modulating the phase. Accordingly, the amount of frequency shift is expressed by the sum of ω_{D2} and ω_{P}, and therefore even if the measurement object TS stays still and ω_{D2} is zero, frequencies can be separated.

### Third Embodiment

In a third embodiment, the second interference signal ISIG2 having a rate of change of interferometric phase different from that of the first interference signal ISIG1 is obtained by moving, by small amounts, the reference object at a high speed, rather than by continuously changing the wavelength of light or modulating the phase of light. In other words, the third embodiment is different from the first and second embodiments in the second processing PR2 for obtaining the second interference signal ISIG2. Accordingly, only the second processing PR2 will be described below, and descriptions of the first processing PR1, the third processing PR3 and the fourth processing PR4 are not given here.

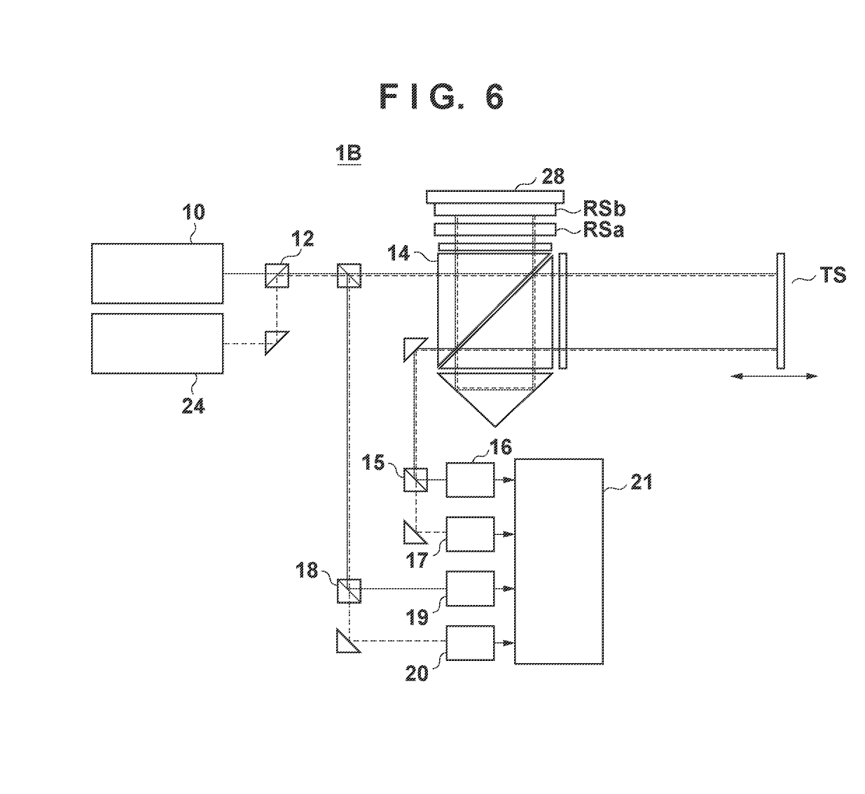

FIG. 6 is a schematic diagram showing a configuration of an interferometer 1B according to a third embodiment. The interferometer 1B is basically a planar interferometer, and includes a plurality of reference objects, namely, a first reference object Rsa and a second reference object RSb, and also includes a stage 28. The interferometer 1B has a double-pass configuration, and therefore the number p of paths from the reference objects to the measurement object is 4.

The first reference object Rsa is the reference object for the light from the first light source 10, and is configured with a light separator element such as a dichroic mirror. The first reference object Rsa reflects the light from the first light source 10 and allows the light from the third light source 24 to pass therethrough. The second reference object RSb is disposed on the stage 28 for moving the second reference object RSb, and reflects the light from the third light source 24.

Obtainment of the second interference signal ISIG2 (the second processing PR2) will be described. In this processing, the processing unit 21 causes the light from the third light source 24 to enter the second reference object RSb and the measurement object TS via an optical path including the polarizing beam splitter 14, while moving the second reference object RSb by using the stage 28. Then, the processing unit 21 controls the detection units so as to detect the second interference signal ISIG2.

For example, if the distance by which the second reference object RSb is moved is indicated by ΔL_{ref} (=λ₂/4), and the cycle in which the second reference object RSb is moved is indicated by τ_{L}, then, the measurement interference signal I_{M2} (t) and a cyclic error CE_{2L} included in the measurement interference signal I_{M2} (t) can be expressed by the following Equation 20.

$${I}_{M 2} ( t ) = {A}_{M 2} cos ( ( {ω}_{R} + {ω}_{D 2} + {ω}_{L} ) t + {φ}_{2} ) + {CE}_{2 L} \\ {CE}_{2 L} = {\sum }_{m} {A}_{2 m} cos ( ( {ω}_{R} + m ( {ω}_{D 2} + {ω}_{L} ) ) t + {φ}_{2 m} ) \qquad ( Equation 20 )$$

In the equations, ω_{D2} (=4 vnk) is the frequency including a Doppler shift caused by movement of the measurement object TS, and ω_{L}=(4nk₂ΔL_{ref}/τ_{L}) is the amount of frequency shift caused by the second reference object RSb being moved. Accordingly, the amount of frequency shift is expressed by the sum of ω_{D2} and ω_{L}, and therefore even if the measurement object TS stays still and ω_{D2} is zero, frequencies can be separated.

With the interferometers described in the second and third embodiments, it is possible to obtain the absolute distance between the reference object and the measurement object in the same manner as the interferometer described in the first embodiment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent application No. 2011-037517 filed on Feb. 23, 2011, which is hereby incorporated by reference herein in its entirety.

What is claimed is:

1. An interferometer that measures a distance between a reference object and a measurement object, the interferometer comprising:
a light splitting element configured to split light from a light source into two light beams and cause one of the light beams to enter the reference object and the other light beam to enter the measurement object;
a detection unit configured to detect interference light between light reflected by the reference object and light reflected by the measurement object and output a signal of the interference light; and
a processing unit configured to perform processing for obtaining the distance using a detection result by the detection unit,
wherein the processing unit performs the following:
fixing a wavelength of the light from the light source, causing the light to enter the reference object and the measurement object via an optical path including the light splitting element, and controlling the detection unit so as to detect interference light between light reflected by the reference object and light reflected by the measurement object and output a first signal;
causing, while continuously changing the wavelength of the light from the light source, the light to enter the reference object and the measurement object via the optical path, and controlling the detection unit so as to detect interference light between light reflected by the reference object and light reflected by the measurement object and output a second signal;
performing frequency analysis on the second signal to calculate a cyclic error included in the second signal;
identifying a cyclic error included in the first signal corresponding to the cyclic error included in the second signal that has been calculated, by using a table showing a correspondence relationship between the cyclic error included in the first signal and the cyclic error included in the second signal; and
subtracting the identified cyclic error from the first signal, and obtaining a phase corresponding to an optical path length between the reference object and the measurement object using the first signal from which is subtracted the identified cyclic error.

2. The interferometer according to claim 1,
wherein the processing unit performs the following:
setting the wavelength of the light from the light source to each of a first reference wavelength, a second reference wavelength and a third reference wavelength, and controlling the detection unit so as to, with respect to each of the first reference wavelength, the second reference wavelength and the third reference wavelength, detect interference light between light reflected by the reference object and light reflected by the measurement object and output a signal of the interference light; and
obtaining the distance by using the phase corresponding to the optical path length between the reference object and the measurement object, the phase being obtained as a result of subtracting the identified cyclic error from the signal output from the detection unit with respect to each of the first reference wavelength, the second reference wavelength and the third reference wavelength, a synthetic wavelength of the first reference wavelength and the second reference wavelength, a synthetic wavelength of the second reference wavelength and the third reference wavelength, and a phase jump value generated when the wavelength is continuously changed from the second reference wavelength to the third reference wavelength.

3. The interferometer according to claim 1,
wherein the frequency analysis includes at least one of fast Fourier transform and discrete Fourier transform.

4. An interferometer that measures a distance between a reference object and a measurement object, the interferometer comprising:
a light splitting element configured to split light from a light source into two light beams and cause one of the light beams to enter the reference object and the other light beam to enter the measurement object;
a detection unit configured to detect interference light between light reflected by the reference object and light reflected by the measurement object and output a signal of the interference light; and
a processing unit configured to perform processing for obtaining the distance using a detection result by the detection unit,
wherein the processing unit performs the following:
fixing a phase of the light from the light source, causing the light to enter the reference object and the measurement object via an optical path including the light splitting element, and controlling the detection unit so as to detect interference light between light reflected by the reference object and light reflected by the measurement object and output a first signal;
causing, while modulating the phase of the light from the light source, the light to enter the reference object and the measurement object via the optical path, and controlling the detection unit so as to detect interference light between light reflected by the reference object and light reflected by the measurement object and output a second signal;
performing frequency analysis on the second signal to calculate a cyclic error included in the second signal;
identifying a cyclic error included in the first signal corresponding to the cyclic error included in the second signal that has been calculated, by using a table showing a correspondence relationship between the cyclic error included in the first signal and the cyclic error included in the second signal; and
subtracting the identified cyclic error from the first signal, and obtaining a phase corresponding to an optical path length between the reference object and the measurement object using the first signal from which is subtracted the identified cyclic error.

5. An interferometer that measures a distance between a reference object and a measurement object, the interferometer comprising:
a light splitting element configured to split light from a light source into two light beams and cause one of the light beams to enter the reference object and the other light beam to enter the measurement object;
a detection unit configured to detect a signal of interference light between light reflected by the reference object and light reflected by the measurement object and output the signal of interference light; and
a processing unit configured to perform processing for obtaining the distance using a detection result by the detection unit,
wherein the processing unit performs the following:
fixing the reference object and causing the light from the light source to enter the reference object and the measurement object via an optical path including the light splitting element, and controlling the detection unit so as to detect interference light between light reflected by the reference object and light reflected by the measurement object and output a first signal;
causing, while moving the reference object, the light from the light source to enter the reference object and the measurement object via the optical path, and controlling the detection unit so as to detect interference light between light reflected by the reference object and light reflected by the measurement object and output a second signal;
performing frequency analysis on the second signal to calculate a cyclic error included in the second signal;
identifying a cyclic error included in the first signal corresponding to the cyclic error included in the second signal that has been calculated, by using a table showing a correspondence relationship between the cyclic error included in the first signal and the cyclic error included in the second signal; and
subtracting the identified cyclic error from the first signal, and obtaining a phase corresponding to an optical path length between the reference object and the measurement object using the first signal from which is subtracted the identified cyclic error.

6. A measurement method for measuring a distance between a reference object and a measurement object by using an interferometer provided with a light splitting element configured to split light from a light source into two light beams and cause one of the light beams to enter the reference object and the other light beam to enter the measurement object and a detection unit configured to detect interference light between light reflected by the reference object and light reflected by the measurement object and output a signal of the interference light, the method comprising the steps in which:
a wavelength of the light from the light source is fixed, the light is caused to enter the reference object and the measurement object via an optical path including the light splitting element, and the detection unit detects interference light between light reflected by the reference object and light reflected by the measurement object and outputs a first signal;
while the wavelength of the light from the light source is continuously changed, the light is caused to enter the reference object and the measurement object via the optical path, and the detection unit detects interference light between light reflected by the reference object and light reflected by the measurement object and outputs a second signal;
frequency analysis is performed on the second signal to calculate a cyclic error included in the second signal;
a cyclic error included in the first signal corresponding to the cyclic error included in the second signal that has been calculated is identified by using a table showing a correspondence relationship between the cyclic error included in the first signal and the cyclic error included in the second signal; and
the identified cyclic error is subtracted from the first signal, and from a result thereof, a phase corresponding to an optical path length between the reference object and the measurement object is obtained.
